(19) United States
(12) Patent Application Publication
(10) Pub. No.: US 2020/0254811 A1
(43) Pub. Date: Aug. 13, 2020

(54) PROCESS, METHOD, AND DEVICE FOR ENHANCING AN ART COMPOSITION

(71) Applicant: David Joseph Catanzaro, Carbondale, PA (US)

(72) Inventor: David Joseph Catanzaro, Carbondale, PA (US)

(21) Appl. No.: 16/790,709

(22) Filed: Feb. 13, 2020

Related U.S. Application Data
(60) Provisional application No. 62/805,196, filed on Feb. 13, 2019.

(51) Int. Cl. B44D 3/00; B44C 1/17

(52) U.S. Cl. CPC B44D 3/00; B44C 1/1704

(57) ABSTRACT

The current invention is a process, method and device for enhancing an art composition. The device for enhancing an art composition is comprised of specialized pieces that make up completed and non-completed illustrations within a user's art composition or drawing. The invention can be used with any art medium including but not limited to, chalk, paint, marker, ink, pencil and charcoal. It can be used by people with autism.

### CROSS-REFERENCES TO RELATED APPLICATIONS (IF ANY)

This application claims the priority date of provisional application 62/805,196 filed on Feb. 13, 2019.

### BACKGROUND

### 1. Field of the Invention

This invention relates to a process, method and device for enhancing an art composition particularly one comprised of specialized pieces which make up completed and non-completed illustrations within a user's art composition or drawing.

### 2. Description of Prior Art

Coloring and how to draw devices are well known in the prior art. For example, there are coloring books and how to draw books along with a combination of both. These books provide a user the means to draw and color in a variety of ways. Some use a connect by number approach to complete an illustration while others use an outline of an incomplete illustration prompting a user to complete the remaining part. After attempting to complete the image, a user has an option to color in the picture or scene thus completing this permanent process.

There exists a need for a process, method and device for enhancing an art composition particularly one comprised of specialized pieces. The specialized pieces could be mobile and reusable. There is still room for improvement in the art.

### SUMMARY OF THE INVENTION

The current invention is a process, method and device for enhancing an art composition. The process, method and device for enhancing an art composition is comprised of specialized pieces that make up different parts of a user's art drawing. The instant invention can be used with any art medium including but not limited to, chalk, paint, marker, ink, pencil and charcoal. It is often times hard for a child to think of something original to draw using just an art medium, the current invention allows a user to overcome this problem.

A process, method and device for enhancing an art composition will further provide a user with a direct immediate connection to imagine the possibilities of the art work they could create with said invention. Chalk or any art medium alone does not provide that same anticipation for a kid that lacks imagination or confidence. Although chalk or any art medium is a tool to create art, the function of the medium is limited by the imagination and ability of a user and its compositional properties. In this respect, having any art medium to create art, could pinhole a child to limiting their usage based on their ability and uninspired creativity. Having a process, method and device for enhancing an art composition with well-defined specialized pieces to be incorporated into a user's art drawing is a much more inspiring and novel approach. A process, method and Device for enhancing an art composition will expand a user's creativity along with giving kids or adults a channel to create art that they never would have created or thought they could.

The disclosed invention will further allow users having a developmental disability such as autism to be more encouraged to draw, having more confidence to further create and imagine providing a better result, allowing them to be more satisfied.

About 1 in 59 children in the United States has autism, according to data released on Apr. 26, 2018 by the U.S. Centers for Disease Control and Prevention (CDC). Four times as many boys as girls have the condition, according to the report. The data is based on a 2014 survey of 325,483 children across 11 states. The data were collected by the CDC's Autism and Developmental Disabilities Monitoring Network (ADDM). These numbers show an increase of nearly 16 percent from the previous prevalence of 1 in 68 children. That estimate was based on data collected in 2012 and had a gender ratio of 4.5 to 1.

Children and adults with autism have trouble expressing themselves through art.

### BRIEF DESCRIPTION OF THE DRAWINGS

Without restricting the full scope of this invention, the preferred form of this invention is illustrated in the following drawings:

FIG. 1 shows a device for enhancing an art composition comprised of specialized pieces;

FIG. 2 shows a user's art composition or drawing including a device for enhancing the art composition comprised of specialized pieces as denoted in FIG. 1;

FIG. 3 shows a device for enhancing an art composition consisting of specialized pieces in the form of things to be incorporated into a pirate scene;

FIG. 4 shows the packaging of a device for enhancing an art composition denoting other things or elements a user could include in their art composition or drawing of a pirate scene;

FIG. 5 shows an art drawing depicting a pirate scene with a device for enhancing an art composition as denoted in FIG. 3; and including other things or elements as denoted in FIG. 4; and

FIG. 6 shows an art composition created with chalk as the medium;

FIG. 7 shows the art composition of FIG. 6 including a device for enhancing the art composition comprised of specialized pieces;

FIG. 8 shows a device for enhancing an art composition comprised of specialized pieces;

FIG. 9 shows a device for enhancing an art composition comprised of specialized pieces made of clear cling vinyl sheets;

FIGS. 10 & 11 show a user's art composition or drawing including a device for enhancing the art composition comprised of specialized pieces made of clear cling vinyl sheets as denoted in FIG. 9; and

FIG. 12 shows different embodiments of a device for enhancing an art composition comprised of specialized pieces.

### DESCRIPTION OF THE PREFERRED EMBODIMENT

The current invention is a process, method and device for enhancing an art composition particularly one comprised of specialized pieces.

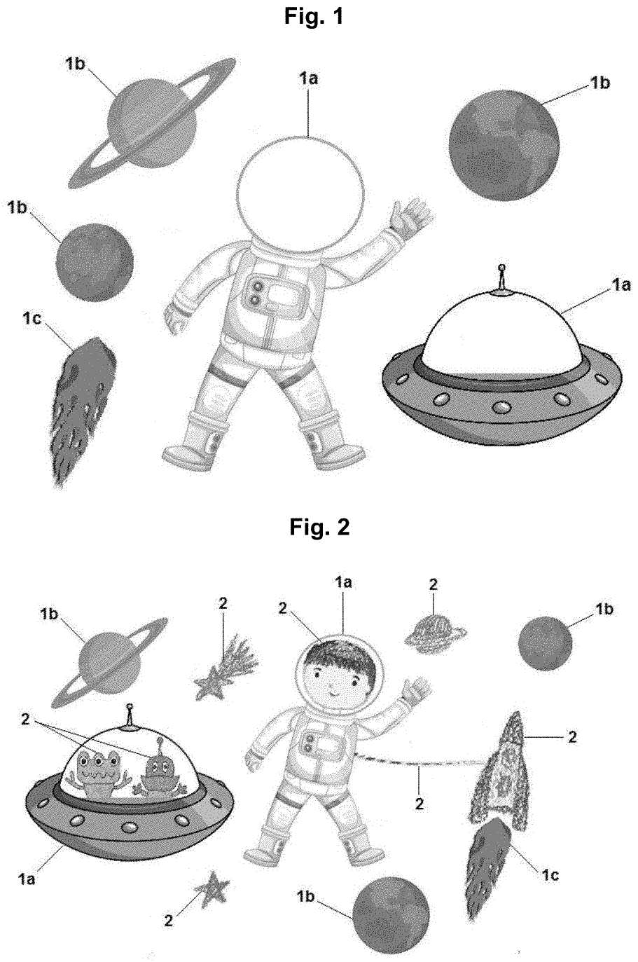

As shown in FIG. 1, the embodiment of the invention drawn shows a process, method and device for enhancing an art composition comprised of specialized pieces 1a, 1b and 1c. Specialized pieces 1a, 1b and 1c are designed to make up different parts of a user's art composition or drawing. Specialized pieces 1a represent incomplete illustrations which promote a user to complete the illustration with any preferred art medium. Specialized pieces 1b represent completed illustrations which enhance a user's art composition or drawing. Specialized pieces 1c represent both specialized pieces 1a and 1b. FIG. 1 further shows a preferred embodiment of specialized pieces 1a, 1b and 1c grouped together within a theme and in this example an outer space theme.

In FIG. 2 the embodiment of the invention drawn shows a process, method and device for enhancing an art composition comprised of specialized pieces 1a, 1b and 1c combined with a user's art drawing 2. A process, method and device for enhancing an art composition can be used with any art medium including but not limited to, chalk, paint, marker, ink, pencil and charcoal. In this example, art drawing 2 of FIG. 2 represents one or all of the following: sidewalk chalk, colored pencils, crayons, markers and paint as the medium. Specialized pieces 1a, 1b and is can be made up of any suitable material that would stay in place on a porous or non-porous surface. The Specialized pieces 1a, 1b and 1c could be made of Clear Cling Vinyl sheets, wherein, when applied to a porous or non-porous surface could have a transparent appearance. Specialized pieces 1a, 1b and 1c can be colored and textured in the manufacturing process to match any art medium. The Specialized pieces 1a, 1b and 1c can also be scented.

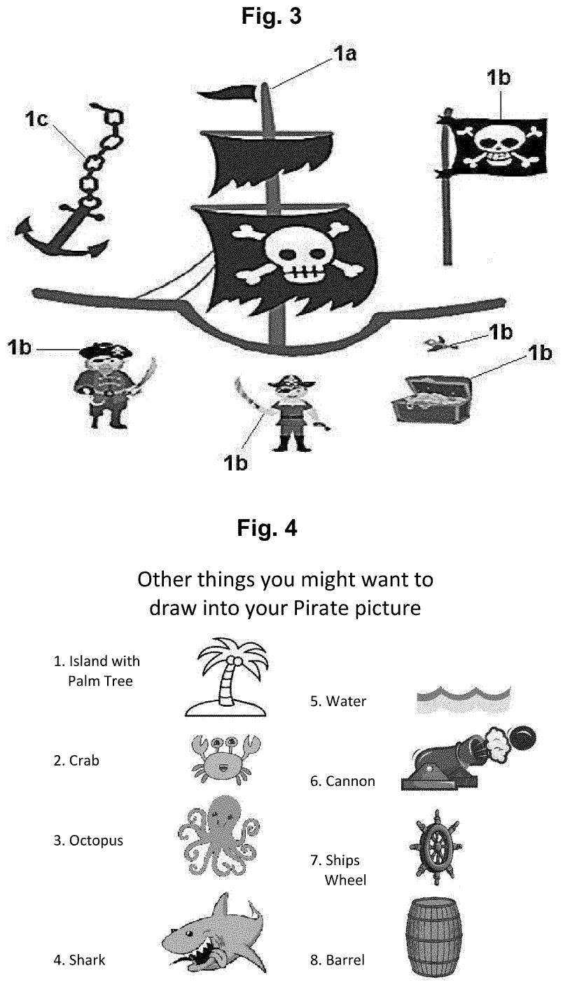

FIG. 3 shows a device for enhancing an art composition consisting of specialized pieces 1a, 1b and 1c in the form of things to be incorporated into a pirate scene. In this pirate scene specialized piece 1a is in the form of an incomplete pirate boat consisting of the sail and right upper deck side portion. Specialized pieces 1b represent a bad and good pirate, treasure chest, parrot and pirate flag. Specialized piece 1c represents a boat anchor. Retail packaging for a device for enhancing an art composition could include illustrations of other theme elements or things that a user could further draw into their art scene. In this example, other elements or things that would make up a pirate scene as shown in FIG. 4.

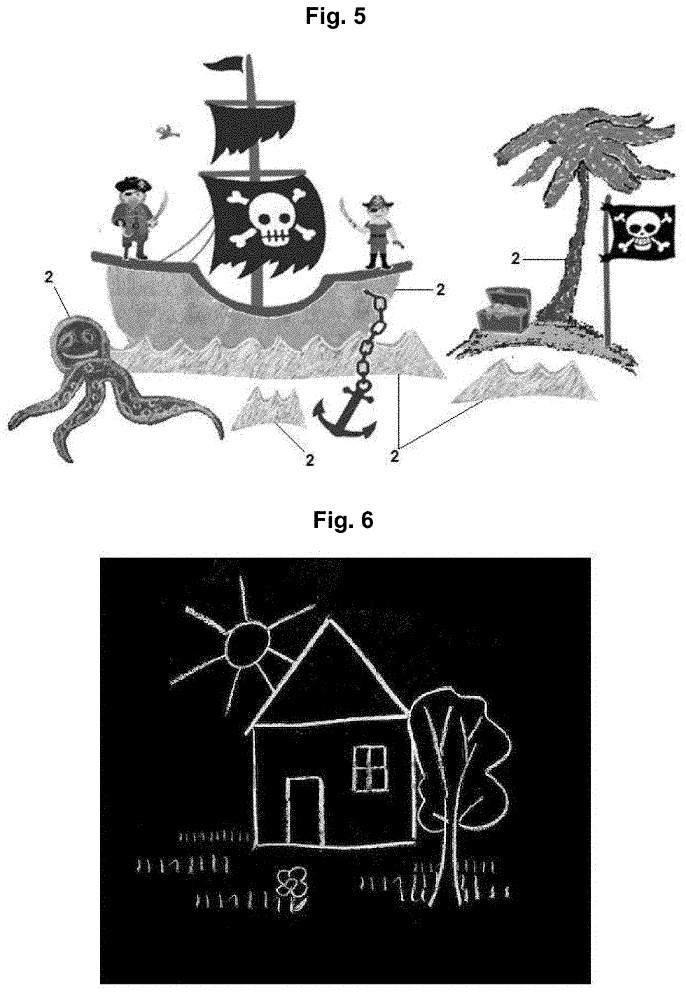

FIG. 5 shows a user's art drawing 2 incorporated with specialized pieces 1a, 1b and 1c of FIG. 3 and further including art illustrations of other elements or things associated with a pirate scene as shown in FIG. 4 incorporated into the user's art drawing 2. A process, method and device for enhancing an art composition allows a user make art that they never otherwise would be creating. The instant invention implores imagination, promotes hidden creativity and provides necessary encouragement for users (especially kids) to expand their art possibilities. It further acts as a support component telling users . . . . You can draw it! Go for it! A kid will now try to draw a pirate boat as shown in FIG. 3 because they now have the means for enhancing their art composition to give them the confidence to achieve it and to feel better about their art.

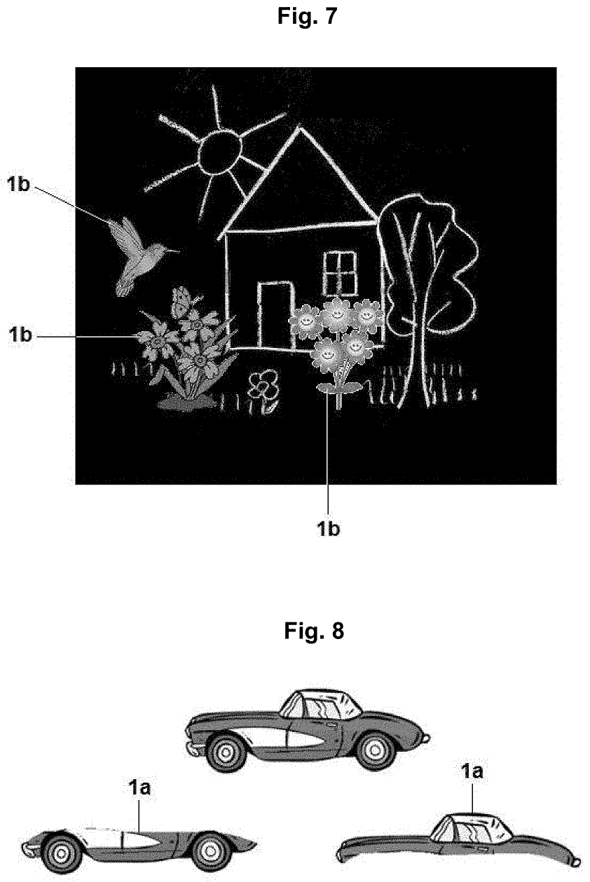

FIG. 6 denotes a typical chalk art drawing created by a child, limited in creativity and imagination denoting simple designs of the sun, a house, grass, tree and a flower. When incorporated with specialized pieces 1b as shown in FIG. 7 the instant invention provides more detail and imagination allowing a user to be more encouraged to draw, having more confidence to further create and imagine resulting in a better result, allowing the child and parent to be more satisfied with the end result.

In another example, FIG. 7 denotes a process, method and device for enhancing an art composition comprised of two specialized pieces 1a which when together take on the form of a classic car. The first specialized piece 1a of FIG. 7 represents the upper portion of the car while the second specialized piece 1a represents the bottom portion of the car. A user now has the opportunity to create art which would complete two separate cars. Having the car image divided into two specialized pieces 1a would allow a user to draw the upper portion of the car onto or right above the lower specialized piece 1a while getting drawing guidance from the upper portion specialized piece 1a, then drawing the lower portion onto or right below the upper portion specialized piece 1a getting drawing guidance from the lower specialized piece 1a hence creating two separate car images. The user then would color each the designated color of its portion.

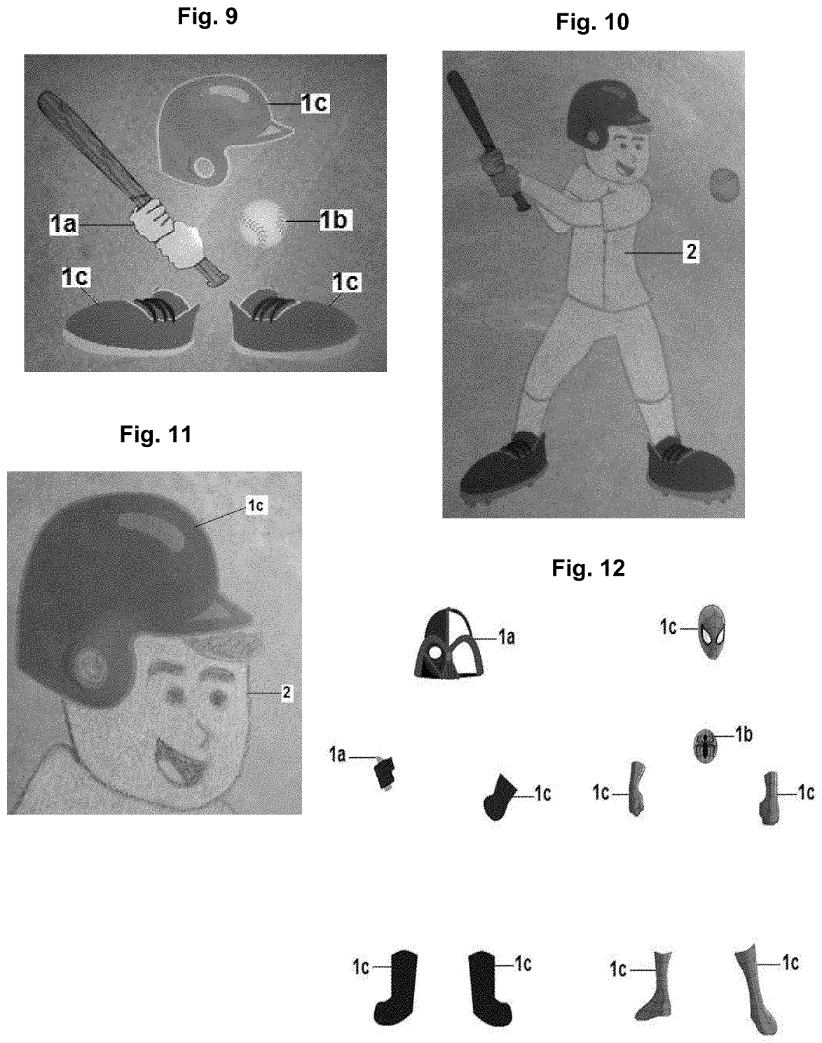

FIG. 9 represents a picture of an actual prototype of specialized pieces 1a, 1b and 1c depicting a baseball players helmet, bat and hands, ball and shoes made of clear cling vinyl sheets. FIG. 10 shows the specialized pieces incorporated with a user's art work 2 which depicts a fully developed baseball player getting ready to hit the specialized piece baseball. FIG. 11 shows a specialized piece 1c (baseball helmet) made of a clear cling vinyl sheet, having a transparent appearance. Specialized pieces 1a, 1b and 1c could be made to be used several times over. The clear cling vinyl sheets used in FIGS. 10 and 11 adhere lightly to the concrete surface when backing is removed and is transparent in design allowing a user to slightly see through the clear cling vinyl sheet exposing the concrete surface beneath as does chalk with its flaky texture. FIG. 11 shows the transparency of the clear cling vinyl along with the texture of the chalk. Both chalk and the clear cling vinyl complement each other in a very good blend. When a user is finished with their art, they could easily reapply the backing of the vinyl sheets and reuse for another time.

FIG. 12 shows different embodiments of the invention comprised of specialized pieces 1a, 1b and 1c promoting a user to draw in the empty parts of the illustrations. A process, method and device for enhancing an art composition could be produced in countless varieties containing small amounts of specialized pieces or many.

Specialized pieces 1a, 1b and 1c could be manufactured to be reusable and mobile.

Although the present invention has been described in considerable detail with reference to certain preferred versions thereof, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
specialized pieces used as parts of an art drawing where the specialized pieces represent incomplete illustrations.

2. A device according to claim 1 comprising:
where the specialized pieces are different parts of an art composition.

3. A device according to claim 2 comprising:
where the art specialized pieces are based on a theme.

4. A device according to claim 1 comprising:
where the specialized pieces are made of clear cling vinyl sheets.

5. A device according to claim 1 comprising:
where the specialized pieces would be one or more of a set of color, texture or scented.

6. A device according to claim 1 comprising:
where the specialized pieces would be reusable.

7. A device according to claim 1 comprising:
where the specialized pieces would be mobile.

8. A device comprising:
specialized pieces used as parts of an art drawing where the specialized pieces represent completed illustrations.

9. A device according to claim 8 comprising:
where the specialized pieces enhance an art composition.

10. A device according to claim 9 comprising:
where the specialized pieces are based on a theme.

11. A device according to claim 8 comprising:
where the specialized pieces are made of clear cling vinyl sheets.

12. A device according to claim 8 comprising:
where the specialized pieces would be one or more of a set of color, texture or scented.

13. A device according to claim 8 comprising:
where the specialized pieces would be reusable.

14. A device according to claim 8 comprising:
where the specialized pieces would be mobile.

15. A process comprising:
Having specialized pieces and using the specialized pieces in an art drawing where the specialized pieces are one or more of the following: incomplete illustrations or completed illustrations.

16. A process according to claim 15 comprising:
where the completed specialized pieces enhance an art composition.

17. A process according to claim 15 comprising:
where the incomplete specialized pieces enhance an art composition and promotes completion of the illustration of the specialized pieces with any preferred art medium.

18. A process according to claim 15 comprising:
where the specialized pieces are made of clear cling vinyl sheets.

19. A device according to claim 15 comprising:
where the specialized pieces would be one or more of a set of color, texture or scented.

20. A process according to claim 15 comprising:
where the specialized pieces would be reusable.
